(19) United States
(12) Patent Application Publication
(10) Pub. No.: US 2005/0232437 A1
(43) Pub. Date: Oct. 20, 2005

(54) Vehicle audio system

(76) Inventors: Rainer Albus, Dormettingen (DE); Adel Bauer, Ludwigsburg (DE); Norbert Niemczyk, Pforzheim (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/470,200

(22) PCT Filed: Dec. 13, 2001
(86) PCT No.: PCT/EP01/14679

§ 371 Date: Dec. 16, 2003

(30) Foreign Application Priority Data
Jan. 25, 2001 (DE) 10103464.4

(51) Int. Cl. H04B 1/00

(52) U.S. Cl. 381/86

(57) ABSTRACT

A vehicle audio system includes an audio central unit, to which one or more further audio components are connected via a first vehicle data bus, and interface means for data communication between the first vehicle data bus and a second vehicle data bus of another type. One of the audio components is an audio gateway unit that contains the interface means, and is formed as an independent component separate from the audio central unit. In addition to data bus gateway functionality, the gateway unit also includes an amplifier functionality, a tuner functionality, one or more further standard audio functionality spanning vehicle types and/or countries, and/or one or more further audio functionalities, which are implemented so as to be parameterizable according to specific vehicle type and/or country. At least one vehicle loudspeaker is connected to the audio gateway unit, which has a control unit that puts the audio gateway unit into an emergency operation mode in the event of failure of the first vehicle data bus, the audio central unit or further audio components. In the emergency operation mode, amplifier and tuner functionality are provided.

### BACKGROUND AND SUMMARY OF THE INVENTION

This application claims the priority of Germany Application No. 101 03 464.4, filed Jan. 25, 2001, the disclosure of which is expressly incorporated by reference herein.

The invention relates to a vehicle audio system having an audio central unit that connects one or more further audio components to one another via a first data bus, and interface means for data communication between the first data bus and a second data bus of another type in the vehicle.

In addition to other known designs of vehicle audio systems (e.g., a distributed system architecture described in H. Tajima et al., “A Distributed Architecture Car Audio System,” Transportation Electronics: Proceedings of the International Congress on Transportation Electronics, Warrendale, Pa., USA, SAE, October 1986, page 85), a vehicle audio system of the generic type mentioned in the introduction (and shown schematically in FIG. 2) is known from vehicles of the applicant. This audio system contains an optical ring data bus 1 (such as, for example, the type commonly known by the abbreviation MOST) which connects a plurality of audio components to one another. One of the latter forms an audio central unit 2 (also called a head unit) in which numerous functionalities are implemented, such as user interface control, bus master function, priority management, diagnosis function, radio and amplifier function etc.

In addition, the conventional central unit 2 contains interface means for data communication between the audio data bus 1 and a second data bus 3, such as is commonly known for example by the abbreviation CAN-B, which connects various vehicle control units to one another. The second data bus 3 is used by the audio central unit 2 to access a combination instrument 4, particularly for display purposes, and to access the rest of the “vehicle control unit environment”, for example to provide a diagnostic function and a multifunction steering wheel function in which one or more audio functions can be controlled on the steering wheel by the system user. The audio central unit 2 controls the other available audio components (in the example shown a car telephone unit 5, a voice control system 6 and a sound system 7 that is an addition to the equipment of a standard system that increases convenience).

The overall range of tasks of the conventional audio central unit 2 is therefore very comprehensive and complex, with at least some of these functionalities being different according to specific vehicle type and/or country, for various types of vehicle and countries of use. Furthermore, the various audio components are often supplied by different component manufacturers for different types of vehicle (in this context, to be understood also to mean different series), and/or for different countries, which reduces the number of units produced for each individual variant, even, and specifically, regarding the conventional audio central unit 2. In addition, a relatively large amount of testing is required for the respective audio system.

A further problematical point in the conventional system is the different loudspeaker system connection. In a standard layout, contact is made with loudspeakers directly at the central unit, whereas, in the case of a convenience-enhancing layout containing the sound system 7, the loudspeakers are connected there, and the output stages of the central unit 2 are then redundant and remain unused. For future standard systems, the four output stages used today will probably no longer be adequate; for technical reasons, it is very difficult, if not possible, to increase the number of output stages in the central unit 2.

One object of the invention is to provide of a vehicle audio system of the type mentioned above, which can be used with comparatively little complication for different types of vehicle, including different series, and also for different countries of use.

Another object of the invention is to provide an audio system which continues to be operational, at least to a limited extent, even if individual components fail.

These and other objects and advantages are achieved by the vehicle audio system according to the invention, which includes an audio gateway unit as a component separate from the audio central unit. The separate audio gateway serves not only as an interface for data communication between the audio data bus and the further data bus of another type in the vehicle, but also has one or more additional functionalities implemented in it, such as an amplifier function, a tuner function and also those functions which are standard for various types of vehicle and/or countries of use, or those which can be parameterized in the audio gateway unit according to specific vehicle type and/or country and which can thus be matched to the respective type of vehicle and to the respective country of use. Since at least one vehicle loudspeaker is connected to the audio gateway unit, and the latter has a control unit which, in the event of failure of the first data bus, of the audio central unit and/or of further audio components, can put the audio gateway unit into an emergency operation mode in which the amplifier functionality and the tuner functionality are provided, at least an emergency mode can be maintained in the event of partial failure of the system.

In this way, the audio central unit can be unencumbered by these functionalities, which significantly reduces its complexity as compared with the conventional system described above and depicted in FIG. 2. This reduction in functionalities to be managed by the audio central unit generally results in fewer different variants of the audio central unit being necessary for the various types of vehicle and countries of use. By implementing the loudspeaker output stage functionality in the audio gateway unit together with a sound system functionality, the audio central unit can be designed without such an output stage, so that the said output stage is prevented from possibly remaining unused. As far as functionalities which are standard in terms of spanning vehicle types and/or countries are concerned, a standard design of the audio gateway unit can be used for all types of vehicles and countries of use. As far as the functionalities which can be parameterized according to specific vehicle type and/or country are concerned, the audio gateway unit can be matched, by appropriate parameterization and hence relatively easily, to the particular instance of vehicle type and to the instance of the country of use, without the need for a great diversity of variants.

Because the amplifier functionality and tuner functionality are provided in emergency operation mode, and at least one loudspeaker is connected to the audio gateway unit, a driver can also be provided with important information, such as traffic news, in emergency operation mode. The provision of an emergency operation mode also reduces the negative impression which failure of functionalities always gives the user.

In one embodiment of the inventin, the audio gateway unit includes means for checking the operability of the first data bus, of the audio central unit and/or of further audio components. In this manner, a partial failure of the system can be detected and the system can be automatically put into the operation mode. In addition, the audio gateway unit can also check the operability of the system in emergency operation mode and can then automatically put the system back into normal mode, or indicate that operability has been restored.

In another embodiment of the invention, starting of the emergency operation mode involves the selection of a station which was received last or a station that has adequate reception quality.

These measures have the advantage that a driver can continue to receive information or music even in the event of partial failure of the system, without having to make adjustments himself. When the emergency operation mode starts, a fundamental state with neutral tone and a minimum volume which is still perceptible can be set. For station selection, priority lies with the last station set, then an attempt is made to set the station stored under station key 1, and only if this also fails is the next station with adequate reception quality set.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a schematic block diagram of a vehicle audio system in accordance with the invention; and

FIG. 2 shows a schematic block diagram of a conventional vehicle audio system.

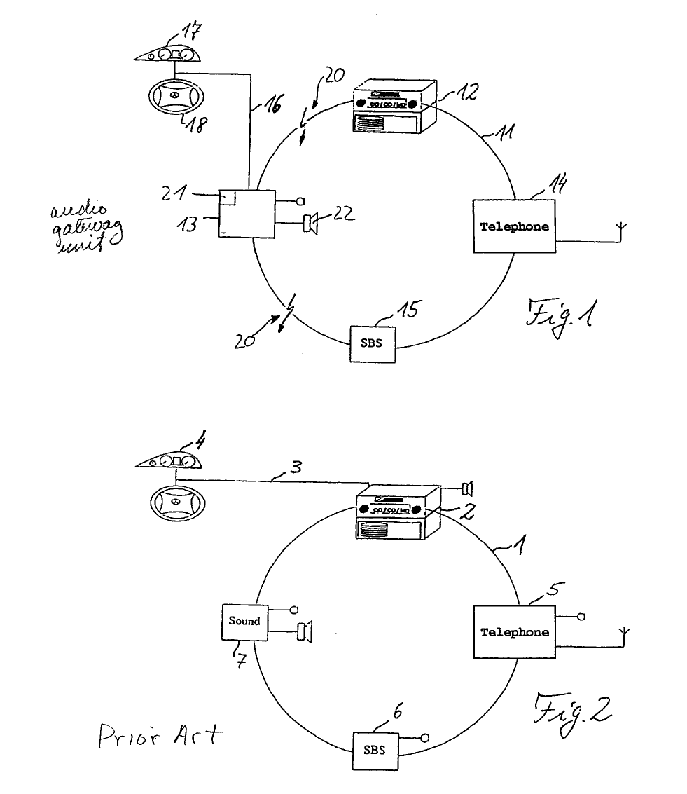

The vehicle audio system according to the invention, shown schematically in FIG. 1, contains an audio data bus 11 in a ring structure (e.g., in the form of a MOST ring bus), that connects an audio central unit 12, an audio gateway unit 13, a car telephone unit 14 and a voice control system unit 15 to one another.

Compared with the conventional system of FIG. 2, the audio central unit 12 in the system according to the invention requires far less functional complexity. Like the conventional central unit 2, it is used as the front end and for user interface (MMI) control, but is also very largely free of the audio functionalities of the conventional central unit 2. In the system according to the invention, these additional functionalities are implemented in the audio gateway unit 13, which is provided as an independent component in addition to the reduced-function audio central unit 12.

In the first instance, the audio gateway unit 13 forms the gateway interface between the audio data bus 11 and a further data bus 16 in the vehicle (for example a data bus of the type CAN-B), which connects the audio system to the rest of the “vehicle environment”, including in particular a combination instrument 17 used primarily for display), a multifunction steering wheel 18, vehicle components which are relevant to diagnosis, and warning tone request means. The additional functions implemented in the audio gateway unit 13 (in addition to the interface function) are uniform for various types of vehicles, including various vehicle series, and/or various countries of use, and are thus standard without requiring any matching specific to vehicle type or country. Alternatively, they are stored such that they can be parameterized in the audio gateway unit 13 according to specific vehicle type and/or country, and can therefore be matched using appropriate parameterization.

In this way, the audio gateway unit 13 realizes an audio system component which spans vehicle types and countries and which contains one or more of the following functionalities, depending on application instance and requirement: first, an amplifier function with a loudspeaker connection is implemented which can be used both for a standard system and for a sound system, so that the audio central unit 12 does not need an amplifier. Second, the audio gateway unit 13 with its interface function serves to provide data interchange with the combination instrument 17 and with the multifunction steering wheel 18 for the purposes of diagnosis and to interchange information with standardized audio-related terminals in the vehicle electrics. Third, the audio gateway unit 13 can have central warning tone management integrated in it, which is particularly advantageous on account of the fact that the audio gateway unit 13 can be used to produce a direct connection to the “vehicle environment”, i.e. the rest of the vehicle electrics, and to produce a direct loudspeaker connection. Fourth, a diagnosis function for performing offboard diagnoses is preferably provided. Fifth, a bus master function for network management in the audio gateway unit 13 can be implemented as a further option. A sixth functionality which can be implemented is applications for starting up and stopping the telematics components contained in the audio system. A seventh functionality concerns the implementation of central administration of the resources (i.e., in particular the capacity of the data transmission channels). Eighth, as mentioned above, a central loudspeaker connection is provided from the audio gateway unit 13. A ninth functionality to be mentioned is the possibility of flexible connection of a subwoofer both for a standard system and for a sound system via the audio gateway unit 13. The tenth function characteristic which can be provided is the connection of not just one but a plurality of microphones to the audio gateway unit 13 (e.g., for a “noise reduction” sound application, a telephone hands-free mode and for the voice control system 15) . The eleventh functionality which should be mentioned is the implementation of the tuner function in the audio gateway unit 13.

Providing the audio gateway unit 13 as a component that is separate from the audio central unit 12 and has the aforementioned function options, provides the following advantages, relative to the conventional system of FIG. 2.

The complexity of the audio system and, in particular, of the audio central unit is reduced. Manufacturers and suppliers of the individual components of the audio system do not need overall knowledge of the system, rather they need know only about individual functions. The use of standard components in the system to span countries and types of vehicle reduces the work involved in development and testing, both for the vehicle manufacturer and the component manufacturer. The central warning tone management allows warning tones to be generated quickly without further delay, specifically at the front, back, to the left and to the right of the vehicle as required, even in the event of a data bus ring dropout. The use of a an SDV (speed-dependent volume) function is not necessary; it is equally possible to use a higher-grade DRO function, as in the sound system. Digital processing of the audio data can be used even with the standard system. The processing of the microphone signals at a central point in the audio gateway unit allows better telephone and voice control system quality to be achieved. Test steps, such as testing the loudspeakers using the microphone, can be automated during the production process. The special “sound system” equipment can easily be retrofitted simply by replacing the audio gateway unit with one having an appropriately higher grade of equipment. The temperature and cabling situation in the vehicle tunnel dome region can easily be kept noncritical, and standard connector designs can be used. An anti-theft function is not necessary in the audio central unit, since, in the minimum configuration, at least two components are required to execute the principal function, namely the audio gateway unit in addition to the audio central unit. The audio central unit, which is preferably built in said dome region, is relatively easy to match to the prevailing circumstances on account of its lower complexity. In addition, the audio gateway unit can easily be used to expand the number of amplifier output stages which is selected nowadays.

in the event of failure of the first data bus 11, of the audio central unit 12, or of the car telephone unit 14 and the voice control system unit 15, if such failure impairs the data communication on the first data bus 11, the vehicle audio system in FIG. 1 can maintain an emergency operation mode in which important audio functions continue to be provided. If, as indicated by the reference numerals 20 in FIG. 1, the first data bus 11 is interrupted, the audio central unit 12 is no longer able to undertake control of the entire audio vehicle system as in the case of fault-free operation. This is the case specifically when the interruption on the first data bus 11 makes data communication thereon entirely impossible, and therefore both directions on the ring of the first data bus 11 have failed.

In order to identify failure of the first data bus 11, the audio gateway unit 13 continuously monitors the operability of the first data bus 11, of the audio central unit 12 and of the telephone unit 14 and of the SBS 15. If the audio gateway unit 13 identifies partial failure of the audio system, then instead of the audio central unit 12, a control unit 21 in the audio gateway unit 13 undertakes control of the remaining system remainder which is still operational. Since the first data bus 11 has failed completely in the case shown in FIG. 1, the system remainder which is still operational comprises just the audio gateway unit 13 with the loudspeaker 22 connected thereto and also the connection via the second data bus 16 to the multifunction steering wheel 18 and to the combination instrument 17. The audio gateway unit 13 contains implementations of both the tuner functionality and of the amplifier functionality. Under the control of the control unit 21, an emergency operation mode can thus maintain radio operation which allows a driver to be provided with important information, for example traffic news. Operation using the multifunction steering wheel 18 and display using the combination instrument 17 are in this case controlled, including control of data communication via the second data bus 16, by the control unit 21.

Following identification of a partial failure of the audio system by the audio gateway unit 13, a predetermined dead time is first awaited, during which attempts are made to start the audio system. If that proves impossible within this dead time, the control unit 21 automatically puts the audio gateway unit 13 into the emergency operation mode. This can be done either during ongoing operation, or following a failed starting procedure for the system.

As noted previously, the control unit 21 undertakes control of the system remainder in the event of partial failure of the system. In this case, the combination instrument 17 connected to the second data bus 16 is used to send advice to the driver that the audio system currently has only restricted functionality.

In the emergency operation mode, broadcast radio reception and audio output via the loudspeaker 22 and possibly via further loudspeakers are ensured, with full sound quality being maintained, depending on the equipment in the vehicle.

When changing to the emergency operation mode, the control unit 21 puts the system remainder (that is, that which is still operational) into a defined fundamental state. In this fundamental state, the last station received (which is still stored in a memory in the audio gateway unit 13 as part of the tuner functionality) is set. If last station received is not available, the station stored(also as part of the tuner functionality), under station key 1 is automatically set. To this end, this information is stored not just in the audio central unit 12 but also in the audio gateway unit 13. Should the station stored for the station key 1 also be unavailable, a station search for the next receivable station is automatically performed. In the fundamental state, the volume is set to a “minimum volume” (which can be found in the specification for a specific vehicle), and the tone settings provide a neutral tonal image, with the balance and fader settings set to the respective center positions.

Control in the emergency operation mode is exercised via the multifunction steering wheel 18, with the functions of volume control and station search being possible. The display instrument used in emergency operation mode is the display of the combination instrument 17. Also, the audio gateway unit 13 checks the operability of the audio system at cyclic intervals. This is done in the background such that a user does not notice. In this regard, in emergency operation mode, the audio gateway unit 13 attempts to start the entire system using a wakeup sequence and thereby checks the state of the audio system. If this wakeup sequence shows that the audio system can be safely started, this can be indicated on the combination instrument 17. The change to normal mode can then be made automatically, or can be made when the audio system is next turned on.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A vehicle audio system having
an audio central unit (12) to which one or more further audio components (14, 15) are connected via an associated first data bus (11), and
interface means for data communication between the first data bus and a second data bus (16) of another type in the vehicle,
characterized in that
one of the audio components is an audio gateway unit (13) which contains the interface means, forms an independent component separately from the audio central unit (12) and in which, apart from the data bus gateway functionality, an amplifier functionality, a tuner functionality, one or more further standard audio functionalities spanning vehicle types and/or countries, and/or one or more further audio functionalities are implemented so as to be parameterizable according to specific vehicle type and/or country, where at least one vehicle loudspeaker (22) is connected to the audio gateway unit (13), and the audio gateway unit (13) has a control unit (21) which, in the event of failure of the first data bus (11), of the audio central unit (12) and/or of further audio components (14, 15), puts the audio gateway unit (13) into an emergency operation mode in which the amplifier functionality and the tuner functionality are provided.

2. The vehicle audio system as claimed in claim 1, further
characterized in that
the audio gateway unit (13) has means for checking the operability of the first data bus (11), of the audio central unit (12) and/or of further audio components (14, 15).

3. The vehicle audio system as claimed in claim 1 or 2,
characterized in that
starting of the emergency operation mode involves a fundamental state being set in which a station received last, a stored station or a station with adequate reception quality is selected.
